(19) United States
(12) Patent Application Publication
(10) Pub. No.: US 2010/0055253 A1
(43) Pub. Date: Mar. 4, 2010

(54) MICRO-ENCAPSULATED CAPSICUM, METHOD FOR PREPARING THE SAME AND USE THEREOF

(75) Inventors: François Gautier, Seynod (FR); Jean-Philippe Meunier, Cessy (FR)

Correspondence Address: WILLIAM H. EILBERG, 316 CALIFORNIA AVE. #785, RENO, NV, 89509, US

(73) Assignee: AXISS FRANCE S.A.S., Bellegarde sur Valserine (FR)

(21) Appl. No.: 12/515,300

(22) PCT Filed: Nov. 20, 2007
(86) PCT No.: PCT/IB2007/054721

§ 371 Date: May 18, 2009

(30) Foreign Application Priority Data
Nov. 21, 2006 (FR) 06 55035

(51) Int. Cl. A23L 1/00; A23L 1/48

(52) U.S. Cl. 426/89; 426/294

(57) ABSTRACT

A food additive or feed ration for an animal contains an active agent including at least one capsaicinoid. The additive or ration is prepared by a method which includes the step of cold-state atomizing of granulating a liquid mixture containing an encapsulation fat, the active agent including at least one capsaicinoid. Solid particles of the mixture are thus produced. The cold-state atomization or the granulation act on the nature of the encapsulating fat, on the particle size, and on the temperature of the atomization step in order to control the capsaicinoid release kinetics in the digestive tract of animals.

### TECHNICAL FIELD OF THE INVENTION

The present invention relates, in general, to compositions for animal feed, food additives for animals, and methods for increasing the zootechnic performance levels of animals.

In livestock farming, the performance levels of the animal feed are generally characterized by the Average Daily Gain (ADG) and/or the food conversion ratio (FCR). The reproductive efficiency of the animals can also be considered.

At the current time, in intensive farming, it is difficult to maintain conditions suitable for optimal growth. Many parameters interact between the animal and its environment, causing, in certain cases, problems which result in a decrease in the expected performance levels in the livestock, and retarded growth.

Digestive disturbances constitute one of the principal causes of animal growth dysfunction.

Antibiotics are commonly used in animal feed, by way of prevention, against such disturbances. This use consequently defines them as “feed growth factor additives”.

However, the repercussions of this practice on consumer health are currently being debated. The emphasis is more particularly on a possible transmission of bacterial resistance from the animal to humans via the food chain.

A second important cause of disturbance is related to the heat stress phenomenon.

Specifically, worldwide production is increasing, in parallel to consumption, and this increase especially concerns developing countries. In these countries, the climatic conditions are not always favorable for many livestock farms. The high ambient temperatures have direct effects, mainly on the reproductive functions of the male or of the female, or indirect effects, via a reduction in food ingestion, on milk production and growth performance levels.

In the face of digestive disturbances, the use of natural plant extracts can be envisaged in order to maintain zootechnic performance levels.

Among the plant extracts, one may imagine using capsaicinoids such as capsaicin (trans 8-methyl-N-vanillyl-6-nonanamide) and dihydrocapsaicin (8-methyl-N-vanillylnonanamide), which are active substances of capsicum. Various properties of capsaicinoids can be exploited in animal feed. Many studies have shown that capsaicinoids 1) have an antimicrobial activity (Cichewicz and Thorpe, 1996), 2) stimulate digestive enzyme and bile secretions (Platel and Srinivasan, 2000) (Platel and Srinivasan, 1996; Platel and Srinivasan, 2004), 3) increase food intake (Curtis and Stricker, 1997), and 4) induce vasodilation in smooth muscles (Chen et al., 1992; Lefebvre et al., 1991) via vanilloid type 1 receptors (VR1). The use of capsaicinoids in animal feed may in particular promote the maintenance of an appropriate blood flow to the reproductive tissues.

These various properties of capsaicinoids are dependent on different sites of action in the digestive tract. Immediate availability of capsaicinoids in the mouth will, for example, promote an increase in food intake, whereas availability in the distal part of the intestine (ileum or colon) will promote an antimicrobial activity.

The biopharmaceutical control of these molecules is therefore imperative in order to be sure that they reach the desired site of action and at the concentration necessary to ensure optimal activity.

Capsaicin is the chemical compound present in capsicum, which produces the spicy nature. The word “capsicum”, as used in the present description, comprises an extract of any plant of the capsicum group, which comprises peppers such as, in a nonlimiting manner, capsicum anuum, capsicum frutescens, capsicum baccatum, capsicum pubescens and capsicum chinense.

Capsaicinoids may be available in the form of a resin extracted from capsicum, called capsicum oleoresin, which is defined as “an exudate composed mainly of resinous compounds and of volatile compounds”. The capsicum oleoresin is a more or less viscous liquid which is hydrophobic in nature and extremely irritant.

The capsicum oleoresin generally contains 0.1% to 20% by weight of natural capsaicin and of capsaicinoids. Higher concentrations can be obtained with a synthetic capsaicin.

The term “capsaicinoids”, as used in the present description, can cover one or more of the following elements: capsaicin, dihydrocapsaicin, capsaicinoids, vanilloids, capsicum, soaked capsicum, ground capsicum, extracts of capsicum, other plants containing capsicum, and combinations thereof.

Capsaicin cannot be used directly by animal feed manufacturers. It is a highly toxic product which requires extremely strict handling conditions, and which must therefore be isolated.

The capsicum oleoresin is easier to use, although it is still a highly irritant product, which limits its direct use as an additive for animal feed. Since it is liquid, the oleoresin is difficult to disperse homogeneously in a feed at the concentrations conventionally used for additives (from a few ppm to a few hundred ppm).

Galenic formulation of the capsicum oleoresin therefore proves to be necessary in order i) to facilitate its homogeneous incorporation into the feed (solid or liquid), ii) to limit the risks of irritation that it can cause, iii) to control its kinetics and its site of release in the digestive tract.

However, the economic and legislative constraints imposed on the animal feed industry greatly limit the techniques and the excipients that can be used for such a development.

Hot atomization, which is the technique most commonly used for microencapsulating plant extracts, cannot be used to meet the various objectives set. This is because the microspheres produced are generally too pulverizing and therefore harmful, which means that the concentrations of capsicum oleoresin that can be microencapsulated must be greatly limited.

Furthermore, it is very difficult to obtain a formulation that can have a delayed effect by using this hot atomization technique.

Document GB1 350 704 A describes the encapsulation of a paprika powder in a tallow matrix. The paprika in solid powder form is dispersed in a solution of ethanol and tallow heated to 50° C. The mixture is then cooled in cold water with vigorous stirring. In addition to the presence of organic solvent, which is not desirable, this method is not suitable in the case of high concentrations of irritant capsaicinoids, in particular in the case of a capsicum oleoresin, the irritant nature of which can be accentuated in the presence of water.

### SUMMARY OF THE INVENTION

The problem proposed by the present invention is to design a technique for preparing food additives or feed rations for animals which makes it possible to substantially increase the concentration of capsaicinoids in the food additive and/or the feed ration, while at the same time limiting the irritant effect of the active molecule.

Another object of the invention is to design such a technique which makes it possible to control the release of the capsaicinoids at different sites of the digestive tract, depending on the desired objective.

Another object of the invention is to promote the effectiveness of capsaicinoids as a function of the various animals that it is desired to feed.

In general, the invention aims to improve the zootechnic performance levels of animal feed, both for animals having rapid transits, such as poultry, and for animals having slower transits, such as pigs, sheep or cattle.

In order to achieve these objectives and others, the invention proposes a method for preparing a food additive or a feed ration for an animal, containing an active agent which includes at least one capsaicinoid, comprising a step of cold-state atomizing, in a gaseous atmosphere, or of granulating, in a gaseous atmosphere in a fluidized airbed, a liquid mixture of an encapsulation fat and of the active agent containing at least one capsaicinoid, thus producing solid particles of said mixture.

It is noted that the cold-state atomizing or granulating step makes it possible to encapsulate concentrations of capsicum oleoresins that can range up to 40%, while at the same time limiting the irritant effect thereof. In addition, these techniques used make it possible to obtain microspheres that can release the capsaicinoids at different sites of the digestive tract depending on the desired objective, by adjusting the parameters of the cold-state atomizing process.

In the method of cold-state atomizing in a gaseous atmosphere, and in the method of granulating in a gaseous atmosphere in a fluidized airbed, the mixture of encapsulation fat and of active agent is initially made liquid by heating, and then forced into a spraying means which sprays it into a cooled gaseous-atmosphere chamber, where the mixture is recovered in the form of a powder.

In the manufacturing process according to the invention, the active agent containing the capsaicinoids may advantageously be a capsicum oleoresin extracted from a plant.

In order to obtain a high concentration of capsaicinoids in the microspheres, it will be preferable to use a capsicum oleoresin having a capsaicinoid concentration at least equal to 0.1% by weight.

Various sources of plants may be used to obtain the capsicum oleoresin. The latter may be obtained from capsicum frutescens or from capsicum anuum, for example.

By means of the method according to the invention, it is possible for the capsicum oleoresin to be present in the solid particles according to a proportion by weight of at least 2.5%, advantageously of at least 5%, more advantageously of at least 20%. The effects of the active product are thus considerably increased when it is used for the animal feed.

In order to adjust the food additive or the feed ration as a function of the anticipated use, i.e. in particular as a function of the animal to be fed and/or of the effect that it is desired to obtain, the parameters of the step of cold-state atomizing in a gaseous atmosphere or of granulating in a gaseous atmosphere in a fluidized airbed are adjusted. For this, during the step of cold-state atomizing in a gaseous atmosphere or of granulating in a gaseous atmosphere in a fluidized airbed, the state of at least one of the following parameters is selected:

a) the nature of the encapsulation fat,
b) the size of the particles,
c) the temperature of the cold-state atomizing or granulating step.

The inventors have in fact demonstrated that these parameters make it possible to act, alone or in combination, on the properties of the food additive thus produced.

For example, in order to delay the release of the capsaicinoids in the digestive tract, glyceryl palmitostearate or glyceryl behenate is chosen as encapsulation fat.

As an alternative or additionally, in order to delay the release of the capsaicinoids in the digestive tract, the size of the particles can be increased by advantageously choosing a particle size of greater than 350 μm, preferably greater than 600 μm.

As an alternative or additionally, in order to delay the release of the capsaicinoids in the digestive tract, the cold-state atomizing or granulating temperature can be reduced by advantageously choosing a temperature of less than −10° C., which can advantageously be of the order of −30° C. to −40° C. This temperature reduction concerns more especially relates to the cold-state atomizing method.

Conversely, in order to accelerate the release of the capsaicinoids in the digestive tract, hydrogenated rapeseed oil can be chosen as encapsulation fat.

As an alternative or additionally, in order to accelerate the release of the capsaicinoids in the digestive tract, the size of the particles can be reduced by advantageously choosing a particle size of less than 350 μm, preferably a size of between 90 μm and 250 μm.

In the case of particles of small size, the risk of producing an irritant effect is increased. To reduce this risk, a water-soluble binder can advantageously be added to the liquid mixture. The water-soluble binder may be a cellulose derivative, a gum or a starch derivative. Hydroxypropylmethylcellulose (HPMC) will advantageously be used.

As an alternative or additionally, in order to accelerate the release of the capsaicinoids in the digestive tract, it is possible, when cold-state atomization or granulation is used, to carry out the atomizing or granulating step at a temperature above −10° C., advantageously between +5° C. and −5° C. If the atomizing temperature is increased above this range, there is a risk of this leading to a notable slowing down of the particle solidifying process during the atomization, and is not therefore desirable.

According to the invention, the zootechnic performance levels of animal feed can be improved by means of a method according to which capsaicinoids galenically formulated by means of the method of preparation as defined above are administered to the animals in the feed ration.

In the case of animals with rapid gastrointestinal transit, such as poultry, the capsaicinoids will be galenically formulated by means of a method of preparation as above, by choosing parameters aimed at increasing the rapidity of release of the capsaicinoids in the digestive tract.

On the other hand, in order to improve the zootechnic performance levels of the feed in animals with slow gastrointestinal transit, such as pigs, sheep or cattle, by improving appetence or digestive enzyme stimulation, capsaicinoids galenically formulated by means of a method of preparation as defined above by choosing parameters aimed at increasing the rapidity of release of the capsaicinoids in the digestive tract will preferably be administered to the animals in the feed ration.

Moreover, in order to improve the zootechnic performance levels of animal feed in animals with slow gastrointestinal transit, such as pigs, sheep or cattle, by promoting an antimicrobial action, capsaicinoids galenically formulated by means of a method of preparation as defined above by choosing parameters aimed at delaying the release of the capsaicinoids in the digestive tract will be administered to the animals in the feed ration.

By virtue of the method of preparation above, the invention makes it possible to design an animal feed containing solid particles based on capsaicinoids encapsulated in a fat, in which a capsicum oleoresin is present in the solid particles in a proportion by weight of at least 2.5%, advantageously of at least 5%, more advantageously of approximately 20%.

In such a feed, a capsicum oleoresin having a capsaicinoid concentration at least equal to 0.1% by weight will preferably be used.

### BRIEF DESCRIPTION OF THE DRAWINGS

Other subjects, characteristics and advantages of the present invention will emerge from the following description of particular embodiments, given in relation to the attached figures, among which:

FIG. 1 illustrates the role played by the nature of the encapsulation fat on the capsaicinoid release kinetics in the digestive tract;

FIG. 2 illustrates the role played by the size of the microspheres on the release of the capsaicinoids in the digestive tract;

FIG. 3 illustrates the role of the atomizing temperature on the rate of capsaicinoid release in the digestive tract;

FIG. 4 illustrates schematically, in section, a cold-state atomizing device;

FIG. 5 illustrates schematically, in section, a granulating device; and

FIG. 6 illustrates the forming of granules in a granulating process.

### DESCRIPTION OF THE PREFERRED EMBODIMENTS

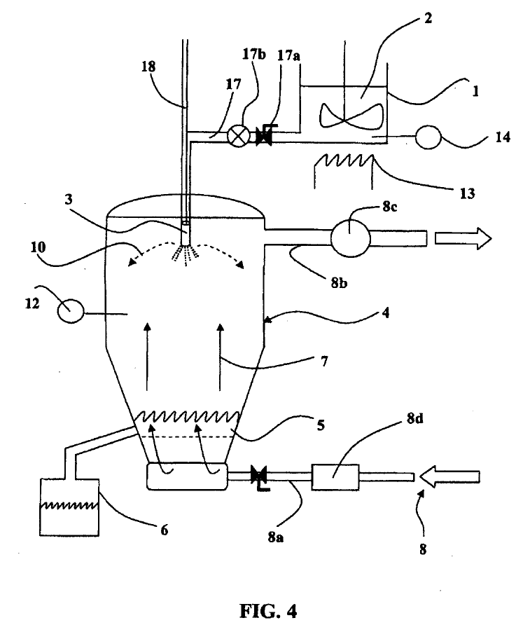

The technology of cold-state atomizing in a gaseous atmosphere, illustrated by the atomizing device of FIG. 4, is first of all considered.

The cold-state atomizing device comprises an atomizing tower 4 of cylindroconical shape, a spraying means 3, such as a spray nozzle or a turbine, in the upper part of the atomizing tower 4, an air/powder separating system in the lower part of the atomizing tower 4, and a collector 6 for recovering the powder. The air/powder separation can be carried out by means of a cyclone system, in which the powder drops into a collector located at the base of the cyclone, whereas the air is expelled via the top by means of a fan. A container 1 comprises heating means 13 such as electrical resistance elements controlled by a sensor 14, so as to make liquid a mixture 2 introduced into the container 1. A pipe 17, with fluid-controlling means such as a valve 17a and a pump 17b, forces the liquid 2 towards the spraying means 3. A ventilation system 8, comprising an inlet pipe 8a, an outlet pipe 8b, a propulsion or suction turbine 8c, and a cooling device 8d, produces, in the atomizing tower 4, a cooled airstream 7, the temperature of which is controlled by a sensor 12. Thus, the internal cavity of the atomizing tower 4 contains a cooled air atmosphere.

In the container 1, an encapsulation fat is heated in order to obtain a liquid, into which the active agent such as capsicum oleoresin is mixed. The heating means 13, such as electrical resistance elements controlled by the sensor 14, keep the liquid mixture 2 at a melting temperature suitable for spraying. The temperature of the liquid mixture 2 before atomizing is kept at a value enabling the fat to melt, and may advantageously be approximately 80° C. At this temperature, the encapsulation fats are liquid oils, and the capsicum oleoresin is also liquid.

The liquid mixture 2 thus obtained is then sprayed by the spraying means 3 in the atomizing tower 4 in which a cooled air atmosphere is maintained at a temperature which makes it possible to rapidly solidify the encapsulation fat in order to obtain homogeneous solid particles 5 which are deposited at the bottom of the atomizing tower 4 and are discharged to the collector 6. The spraying means 3 receives the liquid mixture 2 via the pipe 17.

As spraying means 3, use may be made of a turbine of which the disk-shaped rotor creates a centrifugal force which discharges the liquid in fine droplets 10. The size of the droplets 10 is controlled by the speed of the turbine. As an alternative, use may be made of a pressure nozzle, in which the dispersion energy is provided by the pressure of the liquid pushed by the pump 17b, or a dual-path pneumatic nozzle, with one path (17) for the liquid, the other path (18) for compressed air, which sprays the liquid by shearing the liquid jet with the pressurized air.

In the atomizing tower 4, the gaseous atmosphere comprising a cooled airstream 7 circulates by entering via the inlet pipe 8a and leaving by the outlet pipe 8b, forming a fluidized airbed, whereas the mixture droplets 10 exiting the spraying means 3 move downwards and are set in solid form by the cooled air 7. In the most commonly used systems, the cooled air 7 and the mixture droplets 10 move downwards. As an alternative, the cooled air 7 can move upwards in a counterflow, as illustrated on the figure. The cooling device 8d regulates the temperature of the cooled airstream 7, which determines the temperature of the atomizing tower 4. The temperature sensor 12 supplies the cooling device 8d with information on the temperature in the atomizing tower 4.

Depending on the size of the particles that it is designed to obtain, various types of spraying means 3 are chosen.

For small-to-medium sizes (from 0.01 mm to 0.1 mm in diameter), a nozzle system with a small interior diameter, or a turbine in which the rotor revolves at a relatively rapid speed, will be used.

For larger particle sizes, a nozzle system with a large interior diameter or a rotor which revolves at a relatively slow speed will be used.

It is therefore understood that this technique makes it possible to choose the size of the particles and the temperature inside the atomizing tower 4.

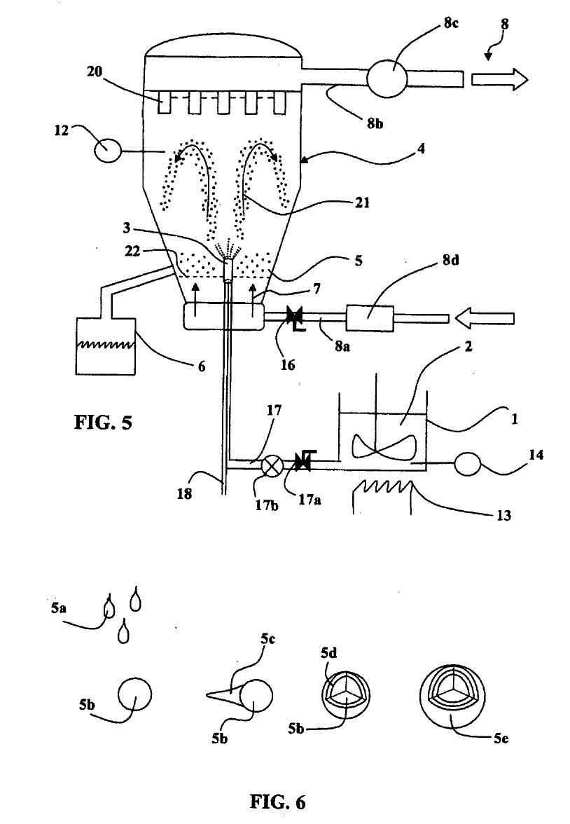

Next, the technique of granulating in a gaseous atmosphere in a fluidized airbed, illustrated by FIGS. 5 and 6, will be considered. This technique reiterates certain means of the above technique of cold-state atomizing in a gaseous atmosphere, these means being denoted by the same numerical references.

In a container 1, an encapsulation fat is heated in order to obtain a liquid, into which the capsicum oleoresin is mixed. The liquid mixture 2 thus obtained is then sprayed by a spraying means 3 into a fluidized-airbed chamber 4 in which a gaseous atmosphere is maintained at a temperature which makes it possible to granulate the encapsulation fat, in successive layers, onto grains of initiating powder, such as grains of silica, in order to obtain solid particles 5. In the fluidized airbed, a cooled airstream 7 circulates from bottom to top, entering by a lower pipe 8a and leaving by an upper pipe 8b comprising suction means 8c, enabling the particles 5 to be maintained in suspension. A cooling device 8d regulates the temperature of the cooled airstream 7, which determines the granulating temperature in the fluidized airbed of the chamber 4. A temperature sensor 12 supplies the cooling device 8d with information on the temperature in the fluidized airbed. Heating means 13, such as electrical resistance elements controlled by a sensor 14, maintain the liquid mixture 2 at a melting temperature suitable for spraying. A valve 17a controls the flow rate of sprayed liquid mixture. A valve 16 controls the flow rate of cooled air. The spraying means 3 receives, on the one hand, the liquid mixture 2 via a pipe 17 and, on the other hand, a spraying gas via a pipe 18. A filter 20, interposed in the chamber 4 upstream of the suction 8c, retains the particles in the chamber 4. The cooled airstream 7 passes through a screen 22, interposed in the chamber 4 upstream of the spraying means 3, which screen supports the particles 5. The spraying can be carried out from bottom to top, as represented on the figure. As an alternative, spraying from top to bottom, or transverse spraying, can be envisaged. In the fluidized airbed, the particles 5 are moved in a “fountain-like” movement illustrated by the arrows 21, moving upwards in the central zone of the chamber 4 and then redescending towards the periphery. The particles obtained are in what is called an onion shape (FIG. 6), having a heterogeneous structure. When the desired particle size is obtained, the particles 5 are expelled from the fluidized airbed to a collector 6.

The granulating steps have been illustrated on FIG. 6: the microdroplets 5a of sprayed encapsulation fat are projected onto grains of initiating powder 5b, and adhere thereto in 5c. The microdroplets distribute and solidify, forming a first layer 5d on the grain of initiating powder 5b. Other microdroplets are then added, resulting in a multilayer onion-type structure 5e.

The inventors have demonstrated that the capsaicinoid release kinetics in the digestive tract of animals depends substantially on the nature of the encapsulation fat, on the size of the particles, and on the temperature of the atomizing or granulating step.

This demonstration was made by using the dissolution techniques described in the European pharmacopeia (2005) and in the US pharmacopeia (USP26), and more particularly by using continuous flow cells.

### The Nature of the Encapsulation Fats

The encapsulation fats that can be used are those based on fats (hydrogenated plant oil, hydrogenated animal oil, wax, . . . ) which are solid at ambient temperature.

The present invention demonstrates the role played by the nature of the encapsulation fat on the capsaicinoid release kinetics.

Initial tests were carried out in order to demonstrate this role.

In these initial tests, two batches F1 and F2 of microspheres were produced by atomizing in an “Aeromatic-Fielder MP1” fluidized airbed, using, as coating matrix for batch F1, hydrogenated rapeseed oil and 20% of capsicum oleoresin (containing 6% of capsaicinoids) (particle size between 90-250 μm), and using, for batch F2, glyceryl palmitostearate (Precirol® ato 5) and 20% of capsicum oleoresin (containing 6% of capsaicinoids) (particle size between 90-250 μm). The atomizing temperature was fixed at +2° C. After production, the microspheres were screened in order to obtain batches of the same particle size.

For each batch produced, 1 gram of microspheres was studied on the Sotax CE 6 dissolution apparatus (cells of 12 mm). A dissolution medium was set up according to the recommendations described in the European pharmacopeia (2005) with the use of a surfactant (Sodium Lauryl Sulfate or SDS) in order to enable capsaicin dissolution. The dissolution medium had the following composition: NaCl (5.0 g/l), KCl (0.6 g/l), CaCl₂ (0.3 g/l) and SDS (10.0 g/l), the pH was fixed at 5. During the experiment, the flow of the dissolution medium through the dissolution apparatus was fixed at 20 ml/min±0.5.

A sample was collected at 5, 10, 15, 20, 30, 40, 60, 90, 120, 135, 150, 165, 180, 240 and 300 min and analyzed by liquid chromatography (HPLC). The dissolution of the oleoresin was monitored by assaying the capsaicin. The method of analysis was set up on a Merck Hitachi Elite Lachrom liquid chromatography (HPLC) system, with a UP5HDO-25Qs column (C18 5μ−250×4.6 mm, Interchrom, France) and a mobile phase composed of water, acetonitrile and acetic acid (55/44.5/0.5, vol/vol/vol) with a flow rate of 1 ml/min. The detection was carried out at 280 nm.

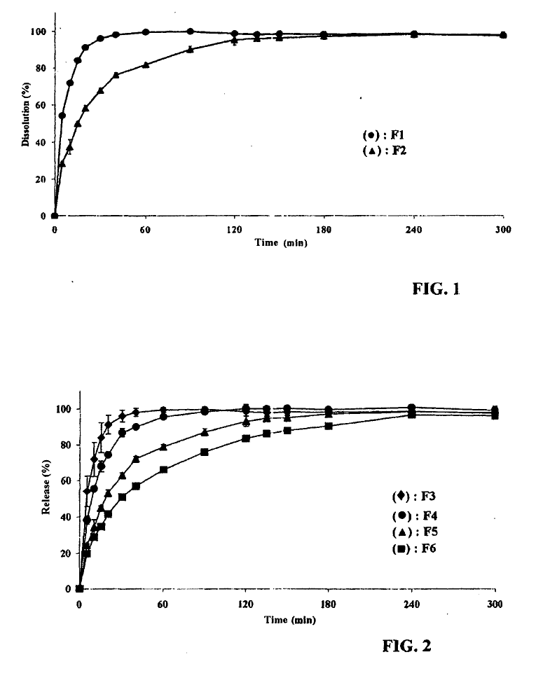

The results of these initial tests are given in FIG. 1. They represent the average of six experiments (± the standard deviation).

It is noted that the dissolution of the capsaicinoids is more rapid for batch F1, in which the encapsulation fat is hydrogenated rapeseed oil, than in batch F2, for which the encapsulation fat is glyceryl palmitostearate.

Thus, glyceryl palmitostearate (Precirol® ato 5) or glyceryl behenate (Compritol® 888 ATO) are fats of which the structure makes it possible to accentuate the delayed capsaicinoid release effect.

Similar results can be obtained with particles produced by granulation.

### Particle Size

The inventors have demonstrated the role played by the particle size on the capsaicinoid release kinetics in the digestive tract.

For this, they carried out a second series of tests, in which the microspheres were produced by atomizing in an “Aeromatic-Fielder MP11” fluidized airbed using, as coating matrix, hydrogenated rapeseed oil and 20% of capsicum oleoresin (containing 6% of capsaicinoids). The atomizing temperature was fixed at +2° C. After production, the microspheres were screened in order to obtain 4 different batches

Batch F3 with a size of [90-250] μm,

Batch F4 with a size of [250-500] μm,

Batch F5 with a size of [500-710] μm,

Batch F6 with a size of [710-1000] μm.

The dissolution kinetics studies were carried out under the same conditions as for example 1.

The results of this second series of tests are given in FIG. 2.

It is noted that the smaller the size of the particles, the faster the rate of release of the capsaicinoids.

This effect can be understood by considering that the release of the capsicum oleoresin from the microspheres obtained by cold-state atomizing occurs mainly by passive diffusion through the matrix of encapsulation fats. A key parameter for controlling this release is the size of the microspheres used. Increasing the size of the microspheres in fact decreases the total contact surface, and therefore the rate of release of the capsicum oleoresin.

The tests demonstrate that particle sizes of less than 350 μm result in a rapid release of the capsaicinoids.

Particles of which the size is greater than 350 μm result in a delayed capsaicinoid release effect.

It should be noted that particles of a size less than 350 μm can result in an irritant product when the capsicum oleoresin concentration is greater than 5%. In order to limit this drawback, a water-soluble binder, such as a cellulose derivative, a gum or a starch derivative, can be added to the mixture to be atomized. The presence of the water-soluble binder causes agglomeration of the microspheres, by creating coarser particles, without however modifying the size of the microspheres themselves, and without modifying the release kinetics in the digestive tract, since the binder used is water-soluble and disappears rapidly.

Similar results can be obtained with particles produced by granulation.

### Atomizing Temperature

The inventors have demonstrated the role played by the atomizing temperature on the capsaicinoid release kinetics in the digestive tract.

For this, they carried out a third series of tests, in which two batches F7 and F8 of microspheres of identical size [500-710] μm were produced by atomizing using, as coating matrix, hydrogenated rapeseed oil and 20% of capsicum oleoresin (containing 6% of capsaicinoids). The first batch F7 was prepared in an “Aeromatic-Fielder MP11” fluidized airbed at an atomizing temperature fixed at +2° C. The second batch F8 was prepared using a vibrating nozzle system (Brace GmbH) at an atomizing temperature fixed at −40° C.

The dissolution kinetics studies were carried out under the same conditions as for example 1.

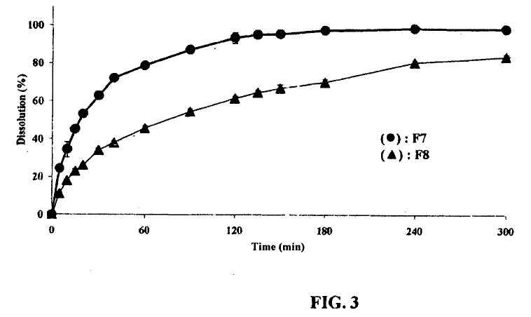

The results of these tests are given in FIG. 3.

It is noted that the second batch F8 atomized at −4° C. produces a much slower capsaicinoid release than the first batch F7 which was atomized at +2° C.

It is thought that the decrease in atomizing temperature results in a modification of the structure of the lipid matrix, thereby resulting in delayed diffusion of the capsaicinoids through this matrix. Thus, applying an atomizing temperature of −40° C. will result in accentuating the delay in release of the capsaicinoids for a microsphere of the same size and of the same composition, with respect to a microsphere obtained by atomizing at a temperature of +2° C.

Similar results can be obtained with microspheres produced by means of a granulating process.

The rapid-release particles can be used for the nutrition of animals having rapid gastrointestinal transits, for example poultry. In this case, one can be sure that the active ingredients will be released before they are excreted by the animal.

These rapid-release particles can also be used for an action on appetence or digestive enzyme stimulation in animals with a slower gastrointestinal transit, for example, pigs, sheep and cattle. In this case, one can be sure that the active ingredients will be released in the first part of the digestive tract (mouth or stomach).

The slow-release particles may be used in order, for example, to promote an antimicrobial action in animals with a slow gastrointestinal transit.

Thus, the techniques used make it possible to obtain microspheres that can release capsaicinoids at different sites of the digestive tract depending on the desired objective, by adjusting only three parameters (nature of the coating matrix, size of the particles, and temperature applied for the manufacture thereof during atomizing or granulating).

The present invention is not limited to the embodiments which have been explicitly described, but it includes the various variants and generalizations thereof contained in the scope of the claims hereinafter.

1. Method for preparing a food additive or a feed ration for an animal, containing an active agent which includes at least one capsaicinoid, comprising a step of cold-state atomizing, in a gaseous atmosphere, or of granulating, in a gaseous atmosphere in a fluidized airbed, a liquid mixture of an encapsulation fat and of the active agent containing at least one capsaicinoid, producing solid particles of said mixture.

2. Method according to claim 1, wherein the mixture of encapsulation fat and of active agent is initially made liquid by heating, and then forced into a spraying means (3) which sprays it into a cooled gaseous-atmosphere chamber (4), where the mixture is recovered in the form of a powder.

3. Method according to claim 1, wherein the active agent containing the capsaicinoids is a capsicum oleoresin extracted from a plant such as capsicum frutescens or capsicum anuum.

4. Method according to claim 3, wherein the capsicum oleoresin has a capsaicinoid concentration at least equal to 0.1% by weight.

5. Method according to claim 4, herein the capsicum oleoresin is present in the solid particles according to a proportion by weight of at least 2.5%, advantageously of at least 5%, more advantageously of at least 20%.

6. Method according to claim 1, wherein, during the step of cold-state atomizing in a gaseous atmosphere or of granulating in a gaseous atmosphere in a fluidized airbed, the state of at least one of the following parameters is selected, depending on the anticipated use of the food additive or of the feed ration:
a) the nature of the encapsulation fat,
b) the size of the particles,
c) the temperature of the cold-state atomizing or granulating step.

7. Method according to claim 6, wherein, in order to delay the release of the capsaicinoids in the digestive tract, glyceryl palmitostearate or glyceryl behenate is chosen as encapsulation fat.

8. Method according to claim 6, wherein, in order to delay the release of the capsaicinoids in the digestive tract, the size of the particles is increased by advantageously choosing a particle size greater than 350 μm, preferably greater than 600 μm.

9. Method according to claim 6, wherein, in order to delay the release of the capsaicinoids in the digestive tract, the cold-state atomizing or granulating temperature is reduced by advantageously choosing a temperature of less than −10° C., which can advantageously be of the order of −30° C. to −40° C.

10. Method according to claim 6, wherein, in order to accelerate the release of the capsaicinoids in the digestive tract, hydrogenated rapeseed oil is chosen as encapsulation fat.

11. Method according to claim 6 wherein, in order to accelerate the release of the capsaicinoids in the digestive tract, the size of the particles can be reduced by advantageously choosing a particle size of less than 350 μm, preferably a size between 90 μm and 250 μm.

12. Method according to claim 11, wherein a water-soluble binder is added to the liquid mixture.

13. Method according to claim 12, wherein the water-soluble binder is a cellulose derivative, a gum or a starch derivative, advantageously hydroxypropylmethylcellulose (HPMC).

14. Method according to claim 6 wherein, in order to accelerate the release of the capsaicinoids in the digestive tract, an atomizing or granulating step is carried out at a temperature above −10° C., advantageously between +5° C. and −5° C.

15. Method for improving the zootechnic performance levels of animal feed, in which capsaicinoids galenically formulated by means of the method of preparation according to claim 1 are administered to the animals in the feed ration.

16. Method for improving the zootechnic performance levels of poultry feed, in which capsaicinoids galenically formulated by means of a method of preparation according to claim 6 are administered to the poultry in the feed ration.

17. Method for improving the zootechnic performance levels of the feed in animals with slow gastrointestinal transit, such as pigs, sheep or cattle, by improving appetence or digestive enzyme stimulation, in which capsaicinoids galenically formulated by means of a method of preparation according to claim 6 are administered to the animals in the feed ration.

18. Method for improving the zootechnic performance levels of animal feed in animals with slow transit, such as pigs, sheep or cattle, by promoting an antimicrobial action, in which capsaicinoids galenically formulated by means of a method of preparation according to claim 6 are administered to the animals in the feed ration.

19. Animal food additive or animal feed containing solid particles based on capsaicinoids encapsulated in a fat, wherein a capsicum oleoresin is present in the solid particles in a proportion by weight of at least 2.5%, advantageously of at least 5%, more advantageously of approximately 20%.

20. Animal food additive or animal feed according to claim 19, wherein the capsicum oleoresin has a capsaicinoid concentration at least equal to 0.1% by weight.

21. Animal food additive or animal feed according to claim 19, wherein the solid particles are agglomerated using a water-soluble binder, such as a cellulose derivative, a gum or a starch derivative, advantageously hydroxypropylmethylcellulose (HPMC).

22. Animal food additive or animal feed according to claim 19, wherein the fat is hydrogenated rapeseed oil or glyceryl palmitostearate or glyceryl behenate.

23. Animal food additive or animal feed according to claim 19, wherein the solid particles have a size greater than 350 μm, preferably greater than 600 μm.

24. Animal food additive or animal feed according to claim 19, wherein the solid particles have a size less than 350 μm, preferably between 90 μm and 250 μm.
